(19) United States
(12) Patent Application Publication
(10) Pub. No.: US 2010/0181236 A1
(43) Pub. Date: Jul. 22, 2010

(54) Wastewater Treatment System

(75) Inventor: Yasuhiko Senda, Itami-shi (JP)

Correspondence Address: Judge Patent Associates, Dojima Building, 5th Floor, 6-8 Nishitemma 2-Chome, Kita-ku, Osaka-Shi, 530-0047, JP

(73) Assignee: SUMITOMO ELECTRIC INDUSTRIES, LTD., Osaka-shi (JP)

(21) Appl. No.: 12/732,210

(22) Filed: Mar. 26, 2010

Related U.S. Application Data
(62) Division of application No. 12/098,448, filed on Apr. 6, 2008.

(30) Foreign Application Priority Data
Apr. 6, 2007 (JP) 2007-100811

(51) Int. Cl. C02F 1/52

(52) U.S. Cl. 210/96.1

(57) ABSTRACT

Even if arsenic-containing wastewater includes an oxidizing substance, the arsenic can be reliably removed as a precipitate. A wastewater treatment method includes a preparation step (S10) of preparing wastewater containing an oxidizing substance and arsenic, a feeding step (S30), a precipitation step (S50), and a post-treatment step (S60). In the feeding step (S30), as much FeCl₂ as necessary to reduce the oxidizing substances, such as polishing agents, is introduced into the wastewater. In the precipitation step (S50), to precipitate out the arsenic as a precipitate from the wastewater as at least a part of the precipitating flocculant, FeCl₃ transformed from the FeCl₂ by its reducing the oxidizing substance is utilized. In the post-treatment step (S60), the precipitate is removed from the wastewater.

### BACKGROUND OF THE INVENTION

1. Technical Field

The present invention relates to wastewater treatment methods and wastewater treatment systems, and more specifically relates to a wastewater treatment method wastewater treatment system for treating wastewater containing oxidizing substances and arsenic.

2. Description of the Related Art

In order to remove arsenic from arsenic-containing wastewater, one technique known to date is to add to the wastewater a metal salt to flocculate/precipitate the arsenic, and then separate the solid matter from the wastewater to remove the arsenic. (Cf. Japanese Unexamined Pat. App. Pub. No. H11-333468, for example.)

One conceivable way of employing the above-described technique as a way to dispose of arsenic-containing wastewater is as follows. Namely: Initially, calcium hydroxide (Ca(OH)₂) is introduced into the wastewater to render the pH of the wastewater highly alkaline. Subsequently, a specific amount of a metal salt—for example, ferric chloride (FeCl₃)—is introduced as a flocculant into the wastewater to lower its pH to near neutral and to coprecipitate the arsenic, and then a flocculation aid is introduced into the wastewater to flocculate/precipitate the arsenic-containing solid matter, and the precipitated solid (precipitate) is eliminated. A technique of this sort makes it possible to remove the arsenic from arsenic-containing wastewater as a precipitate (sludge).

Nevertheless, in employing the above-described method, in some cases the precipitation in the wastewater retards, such that the arsenic cannot be substantially eliminated from the wastewater. One conventional approach to dealing with such situations has been to dilute by several times the wastewater being treated, and then apply the above-described treatment method to remove the arsenic. The present inventors investigated wastewater in instances in which removing arsenic in this way was not possible. Their results revealed that with wastewater containing a large amount of polishing agents and other oxidizing substances in the slurry, arsenic removal in the manner described above will not prove successful.

### BRIEF SUMMARY OF THE INVENTION

An object of the present invention, brought about to resolve the problems noted above, is to make available a method and system for treating arsenic-containing wastewater that enable the reliable removal of the arsenic as a precipitate even in instances in which the wastewater includes oxidizing substances.

As a result of investigating the phenomenon in which precipitation retards in wastewater including an oxidizing substance, the inventors came to the realization that if the oxidizing substance in the wastewater can be reduced, the arsenic can be removed from the wastewater by a flocculation/precipitation technique employing a flocculant (FeCl₃ for example) like those that are traditional. Furthermore, if a ferrous salt is utilized in order to reduce the oxidizing substance, the reduction of the oxidizing substance transforms (oxidizes) the ferrous salt containing bivalent iron into a ferric salt containing trivalent iron. Then this ferric salt, acting as a flocculant, is needed also in precipitating the arsenic.

The inventors also studied other substances, apart from ferrous salts, as reducing agents for reducing oxidizing substances in wastewater. For example, hydrogen peroxide (H₂O₂) was added as a reducing agent, in which case the hydrogen peroxide made reduction of the oxidizing substances possible. The problem with adding hydrogen peroxide, however, was that it generated bubbles in the wastewater, and consequently flocculated solid matter was prevented by the bubbles from precipitating. In another instance, sodium thiosulfate was added as a reducing agent to the wastewater, in which case reduction of the oxidizing substances was also made possible. The problem with adding sodium thiosulfate, however, was that it increased the total ion count within the wastewater, lowering the precipitability of the flocculated solid matter in the wastewater. Consequently, employing sodium thiosulfate as a reducing agent required introducing into the wastewater a greater amount of flocculation aid. Thus it was concluded that, as reducing agents for reducing oxidizing substances in wastewater, ferrous salts are best suited as materials that can be utilized without causing the problems discussed above (the problems of bubble generation and compromised precipitability).

Based on findings such as noted above, a wastewater treatment method in accordance with one aspect of the present invention is a method of treating wastewater containing an oxidizing substance and arsenic, and is provided with: a step of preparing the wastewater containing an oxidizing substance and arsenic; a treatment step; a precipitation step; and a separation step. In the treatment step, an amount of ferrous salt necessary to reduce the oxidizing substance is introduced into the wastewater. In the precipitation step, the arsenic is precipitated out from the wastewater as a precipitate utilizing, as at least a part of the flocculant, ferric salt transformed from the ferrous salt by the reduction of the oxidizing substance. In the separation step, the precipitate is separated from the wastewater.

Thus designed, the method promotes precipitation of arsenic because oxidizing substances that are a factor inhibiting arsenic precipitation can be reduced by the ferrous salt. Furthermore, the ferric salt crated by the ferrous salt being oxidized by reducing the oxidizing substances acts as a flocculant in the flocculation-precipitation process for removing the arsenic. On this account, the amount of material introduced as a flocculant can be reduced over the situation in which a flocculant is added to the wastewater separately from the reducing agent for reducing oxidizing substances—as in the situation in which another substance (not utilizable as a flocculant) is employed in order to reduce the oxidizing substances.

It should be understood that in a wastewater treatment method of the present invention, FeCl₂ can be utilized as ferrous salt, and FeCl₃ as the ferric salt. Alternatively, FeSO₄ can be utilized as the ferrous salt.

In the treatment step of the foregoing wastewater treatment method, the oxidation-reduction potential of the wastewater may be assayed to determine, based on the assay results from measuring the oxidation-reduction potential of the wastewater, whether the amount of ferrous salt introduced has reached the level necessary to reduce the oxidizing substance. Herein, wastewater containing an oxidizing substance will indicate a relatively high oxidation-reduction potential, on the plus side, but after reduction of the oxidizing substance in the wastewater by the ferrous salt is complete, the oxidation-reduction potential will go to being zero or on the minus side. Therefore, measuring the wastewater oxidation-reduction potential makes it possible to check whether or not reduction of the oxidizing substance has completed. That is, whether the amount of ferrous salt necessary to reduce the oxidizing substance has been introduced into the wastewater is determined from the measurement result. The determination thus enables introducing into the wastewater ferrous salt in the sufficient quantity needed for reduction of the oxidizing substance. In turn, reducing the oxidizing substance in the wastewater with dependable certainty ensures precipitation of the solid matter, as a result allowing removal of arsenic from the wastewater to be carried out assuredly.

What is more, excessive introduction of ferrous salt into the wastewater can be prevented, making it possible to prevent ferrous salt from remaining in excess in the post-processed effluent (that is, in the wastewater after the precipitate has been removed).

In accordance with another aspect of the present invention, a wastewater treatment system is a system for treating wastewater containing an oxidizing substance and arsenic, and is provided with a reaction vessel, a measuring device, and a feeding device. The reaction vessel holds the wastewater. The measuring device measures the oxidation-reduction potential of the wastewater held in the reaction vessel. The feeding device introduces ferrous salt into the reaction vessel, based on the output from the measuring device.

Designed in this way, the wastewater treatment system makes it possible to determine, according to the output from the measuring device, whether or not the amount of ferrous salt necessary to reduce the oxidizing substance has been introduced into the wastewater. As a result, ferrous salt can be introduced into the wastewater in the sufficient quantity needed for reduction of the oxidizing substance. In turn, reducing the oxidizing substance in the wastewater with dependable certainty allows precipitation of the solid matter within the wastewater to take place reliably. As a result, removal of arsenic from the wastewater can be carried out assuredly.

According to the present invention, even in situations in which an oxidizing substance is included in wastewater containing arsenic, the arsenic can be dependably removed from the wastewater by a flocculation-precipitation technique.

From the following detailed description in conjunction with the accompanying drawings, the foregoing and other objects, features, aspects and advantages of the present invention will become readily apparent to those skilled in the art.

### BRIEF DESCRIPTION OF THE SEVERAL VIEWS OF THE DRAWINGS

FIG. 1 is a flow chart for explaining a wastewater treatment method in accordance with the present invention.

FIG. 2 is a flow chart for explaining in detail the FeCl₃ and FeCl₂ introducing step in the flow chart presented in FIG. 1.

FIG. 3 is a graph plotting the relationship in wastewater between oxidation-reduction potential (ORP) and pH, in an instance in which the wastewater treatment method represented in FIG. 1 is implemented.

FIG. 4 is a schematic diagram illustrating the configuration of a wastewater treatment system for implementing the wastewater treatment method represented in FIG. 1.

### DETAILED DESCRIPTION OF THE INVENTION

Hereinafter, referring to the accompanying drawings, an explanation of embodiments of the present invention will be made in detail. It should be understood that in the following description, with the same reference marks being used for identical or equivalent features, reduplicating description will be omitted.

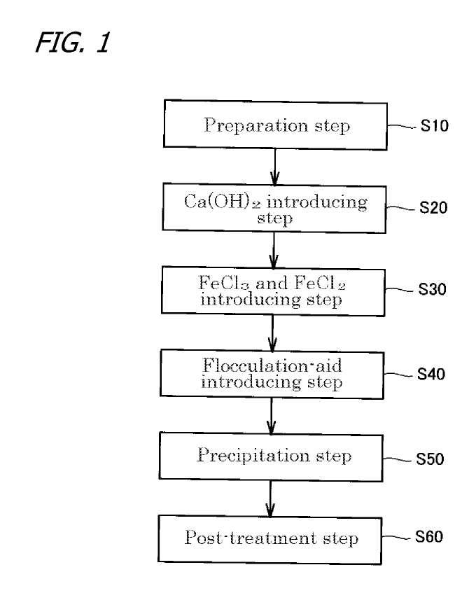

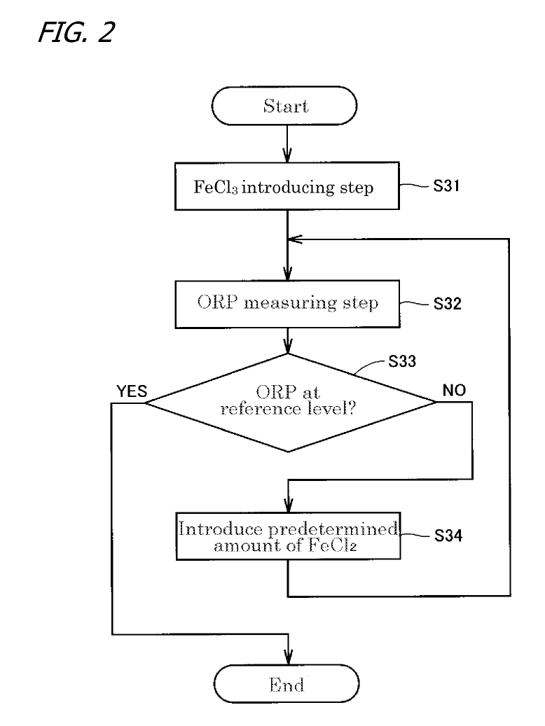

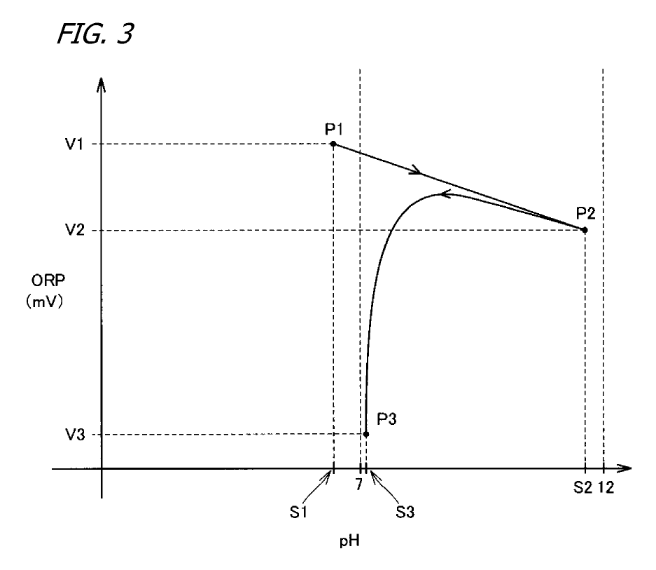

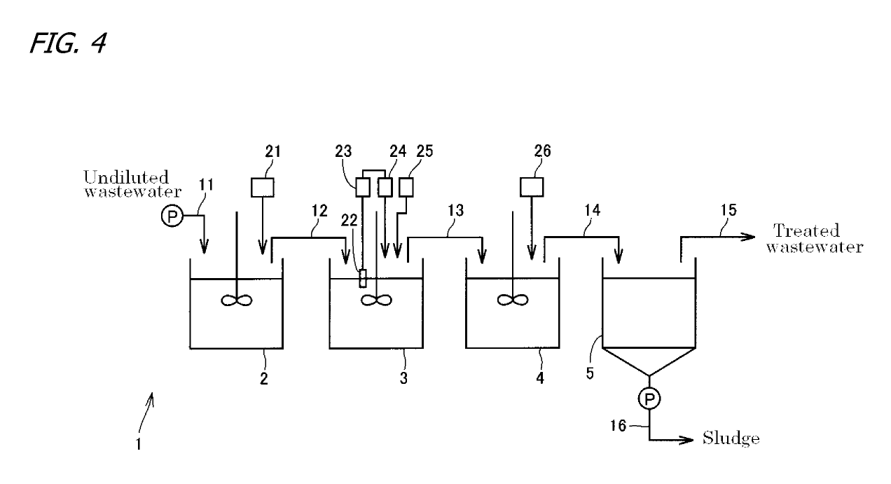

FIG. 1 is a flow chart for explaining the wastewater treatment method of the present invention. FIG. 2 is a flow chart for explaining in detail the FeCl₃ and FeCl₂ introducing step in the flow chart represented in FIG. 1. FIG. 3 is a graph demonstrating the relationship between the oxidation-reduction potential (ORP) and the pH, established in the wastewater when the wastewater treatment method represented in FIG. 1 is carried out. FIG. 4 is a schematic diagram illustrating the wastewater treatment system structure for carrying out the wastewater treatment method represented in FIG. 1. Referring to FIGS. 1 through 4, the wastewater treatment method and system of the present invention will be described.

With reference to FIG. 1, in the wastewater treatment method of the present invention, a preparation step (S10) of preparing arsenic-containing wastewater including oxidizing substances is carried out, first. Specifically, the wastewater is poured into the predetermined reaction vessel in the preparation step (S10).

Next, in order to control the wastewater pH, a Ca(OH)₂ introducing step (S20) as a pH adjusting step of introducing calcium hydroxide (Ca(OH)₂) into the wastewater to control the wastewater pH so as to be the predetermined value is carried out. The wastewater pH is controlled to fall within the range, for example, of from 11.5 to 11.8, inclusive, by this step (S20).

Successively, a FeCl₃ and FeCl₂ introducing step (S30) is carried out. In this step (S30), specifically, the predetermined fixed amount of FeCl₃ and the only amount of FeCl₂ necessary to reduce the oxidizing substances in the wastewater are introduced into the wastewater. A specific example of the step (S30) will be described with reference to FIG. 2.

As represented in FIG. 2, in the step (S30) described above, a FeCl₃ introducing step (S31) is carried out, first. In this step (S31), the predetermined fixed amount of FeCl₃ is introduced into the wastewater. The introduced FeCl₃ acts as flocculant.

Next, an ORP measuring step (S32) is carried out. In this step (S32), oxidation-reduction potential of the wastewater is measured, for example, with any measuring device conventionally well known.

Subsequently, a step (S33) of determining whether or not the measured ORP reaches a criterion level is carried out. In the step (S33), the measured ORP is compared with the predetermined criterion level to decide whether or not the measured ORP and the criterion level are equal. As the criterion level, the ORP at which all the oxidizing substances in the wastewater are reduced is utilized. If it was decided in the step (S33) that the measured ORP and criterion level are equal, all the oxidizing substances in the wastewater are believed to be reduced by the FeCl₃. Therefore, the step (S30) is finished. On the other hand, if it was decided in the step (S33) that they are not equal, a part of the oxidizing substances remaining to be reduced is believed to be present in the wastewater, and thus a step (S34) of introducing the predetermined amount of FeCl₂ into the wastewater is carried out. In the step (S34), the predetermined foxed amount of FeCl₂ is introduced into the wastewater. After the step (S34) is finished, the step (S32) is carried out again. As just described, the steps (S32 through S34) are repeated until the measured ORP reaches the criterion level in the step (S33).

Herein, although the step (S31) of introducing a fixed amount of FeCl₃ is carried out in the flow chart represented in FIG. 2, the step (S31) may be omitted depending on the conditions for the wastewater (that is, only FeCl₂ may be introduced into the wastewater, as in the step (S34)).

Next, a flocculation-aid introducing step (S40) is carried out as represented in FIG. 1. As the flocculation aid, acrylamide-sodium acrylate copolymer (a chemical substance identified by, for example, CAS number: 25085-02-3) can be principally utilizable.

Successively, a precipitation step (S50) is carried out. In the precipitation step (S50), specifically, with the wastewater into which the flocculation aid has been introduced being stored in, for example, a precipitation vessel, solid matter flocculated in the wastewater is precipitated as described above. The solid matter contains arsenic.

After the solid matter is precipitated, a post-treatment step (S60) including a process of removing from the wastewater the solid matter (precipitates) precipitated in the wastewater (for example, a process of discharging from the precipitation vessel a treated solution left after the solid matter is precipitated, and of taking out from the precipitation vessel to the outside the precipitates accumulated on the bottom of the precipitation vessel) is carried out. Removing the solid matter from the wastewater means that arsenic is removed as a precipitate from the wastewater, making it possible to decrease arsenic concentration in the treated solution.

As described above, in the wastewater treatment method, the wastewater ORP is measured in order to decide the amount of introduced FeCl₂. A relationship between the wastewater ORP and pH in the wastewater treatment method will be briefly described with reference to FIG. 3.

As demonstrated in FIG. 3, in the wastewater treatment method, the wastewater ORP and pH varies with the introduction of a chemical agent. In FIG. 3, the horizontal axis represents the wastewater pH and the vertical axis represents the ORP. The ORP units are mV. As shown in FIG. 3, an undiluted solution of wastewater before start of wastewater treatment has the ORP and pH values shown by the point P1. As given by the point P1, the ORP V1 of the undiluted solution could be assumed to be 700 mV for example, and the pH S1 to be 6.8 for example.

Then, carrying out the step (S20) in FIG. 1 varies the wastewater ORP and pH from the point P1 to a point P2, as demonstrated in FIG. 3. For example, the possible ORP and pH at the point P2 are respectively 460 mV and 11.8.

Next, carrying out the step (S30) in FIG. 1 varies the wastewater ORP and pH from the point P2 to a point P3, as demonstrated in FIG. 3. That is, introducing FeCl₂ into the wastewater leads to reduction of the oxidizing substances in the wastewater, and the wastewater ORP lowers with the reduction, as demonstrated in FIG. 3. Moreover, the wastewater pH decreases approximately to 7 with the introduction of FeCl₃ and FeCl₂ in step (S30). Presumably, the ORP of V3 and pH of S3 at the point P3 are respectively 30 mV and 7.3, for example. The ORP of V3 corresponds to the criterion level employed in the step (S33) represented in FIG. 2.

Successively, referring to FIG. 4, the wastewater treatment system enabling carrying out above wastewater treatment method will be described.

With reference to FIG. 4, a wastewater treatment system 1 is provided with a pH adjusting vessel 2, a reaction vessel 3, a flocculation vessel 4, a precipitation vessel 5, feeding devices 21 and 24 to 26, a measuring device 22 for measuring the wastewater ORP, and a control section 23. In the pH adjustment vessel 2, a supply pipe through which undiluted solution of the wastewater that will be treated can be introduced as represented with an arrow 11 is disposed. Furthermore, in the pH adjusting vessel 2, the feeding device 21 for introducing a pH adjuster (for example, Ca(OH)₂) into the pH adjusting vessel 2. The step (S20) represented in FIG. 1 is carried out in the pH adjustment vessel 2.

In the reaction vessel 3, a supply pipe for from the pH adjusting vessel 2, as represented with an arrow 12, supplying the wastewater whose pH has been adjusted is disposed. The pH-adjusted wastewater supply pipe is provided with a not-illustrated transferring member (for example, a pump). Furthermore, in the reaction vessel 3, the feeding device 25 for introducing FeCl₃, and feeding device 24 for introducing FeCl₂, into the reaction vessel 3 are disposed. Also, the measuring device 22 for measuring oxidation-reduction potential (ORP) of the wastewater stored inside the reaction vessel 3 is disposed in the reaction vessel 3. Moreover, measurement result from the measuring device 22 is input in the control section 23 connected to the measuring device 22. The control section 23 controls the FeCl₂ feeding device 24, based on the input measurement result data. As to what the control section 23 controls, for example, the amount of introduced FeCl₂ can be controlled based on the flow chart represented in FIG. 2. The step (S30) represented in FIG. 1 is carried out in the reaction vessel.

In the flocculation vessel 4, a supply pipe for from the reaction vessel 3, as represented with an arrow 13, supplying the wastewater into which FeCl₂ has been introduced is disposed. The FeCl₂-introduced wastewater supply pipe is provided with a not-illustrated pump for transferring the wastewater. In the flocculation vessel 4, the charging device 26 for introducing a flocculation aid into the flocculation vessel 4 is disposed. The step (S40) represented in FIG. 1 is carried out in the flocculation vessel 4.

In the precipitation vessel 5, a supply pipe for from the flocculation vessel 4, as represented with an arrow 14, supplying the wastewater into which the flocculation aid has been introduced is disposed. The flocculation aid-introduced wastewater supply pipe is provided with a not-illustrated pump for transferring the wastewater. On the bottom of the precipitation vessel 5, a discharging mechanism (such as a discharge pipe as represented with an arrow 16) for discharging the precipitates (sludge) that are the solid matter accumulated on the bottom of the precipitation vessel 5 is disposed. Also, a pipe for discharging a (treated) solution other than the precipitates, as represented with an arrow 15, from the precipitation vessel 5 to the outside. The treated-solution discharge pipe is provided with a pump. Furthermore, the pH adjusting vessel 2, reaction vessel 3, and flocculation vessel 4 are provided with a propeller or other stirring members rotatable on a motor, because the wastewater that these vessels each store is stirred. The steps (S50 and S60) represented in FIG. 1 are carried out in the precipitation vessel 5.

Although partially overlapped with above embodiment, a characteristic structure of the present invention is summarized below: the wastewater treatment method of the present invention is the method of treating wastewater containing oxidizing substances and arsenic, and is provided with a preparation step (S10) of preparing the wastewater containing oxidizing substances and arsenic, the step (S30) as the treatment step, the precipitation step (S50), and the post-treatment step (S60) as separation step. In the step (S30), the amount of FeCl₂ as the ferrous salt necessary to reduce the oxidizing substances such as polishing agents is introduced into the wastewater. In the precipitation step (S50), FeCl₃ as the ferric salt transformed from the FeCl₂ by its reducing the oxidizing substances is utilized as at least a part of flocculant to precipitate the arsenic out from the wastewater as a precipitate. In the post-treatment step (S60), the precipitates are separated from the wastewater.

In such a wastewater treatment method, the oxidizing substances that are a factor inhibiting the arsenic precipitation are reduced by the FeCl₂, and thus the arsenic precipitation can be prompted. Furthermore, FeCl₃ generated by reducing the oxidizing substances acts as flocculant in the flocculation-precipitation process for removing arsenic. For this reason, the wastewater treatment method makes the amount of a substance introduced as flocculant smaller than adding, separately from a reducing agent for reducing oxidizing substances, a flocculant to wastewater as employing another substance (not utilizable as flocculant) in order to reduce the oxidizing substances.

In the step (S30) of the wastewater treatment method, as represented in FIG. 2, the wastewater oxidation-reduction potential (ORP) is measured to determine, based on the wastewater ORP measurement result, whether or not the amount of charged FeCl₂ reaches the necessary level to reduce the oxidizing substances. More specifically, the ORP measurement result may be compared with the predetermined criterion level to decide the amount of charged FeCl₂, based on the comparison result. Moreover, as to the criterion level for deciding the amount of charged FeCl₂ based on the comparison result, whether or not the ORP measurement result equals the criterion level is utilized.

Herein, the ORP of the wastewater containing oxidizing substances is relatively higher on the plus side, but after the reduction of the oxidizing substances in the wastewater by FeCl₂ is completed, the ORP changes to 0 or to on the minus side. Therefore, measuring the wastewater ORP makes it possible to check whether or not the oxidizing-substance reduction is completed. That is, whether or not the amount of FeCl₂ necessary to reduce the oxidizing substances is determined from the measurement result. Consequently, such a determination enables introducing into the wastewater as much FeCl₂ as necessary enough to reduce the oxidizing substances. And, completely reducing the oxidizing substances in the wastewater ensures precipitation of the solid matter, resulting in that the arsenic is reliably removed from the wastewater.

Moreover, excessive introduction of FeCl₂ can be prevented, which means that the FeCl₂ is prevented from excessively remaining in solution discharged after the treatment (that is, in the wastewater from which the precipitates have been removed).

Herein, in the wastewater treatment method described above, FeCl₂ as ferrous salt may alone be introduced into the wastewater in the step (S30) corresponding to the treatment step. Alternatively, in addition to introducing a preestablished amount of FeCl₃ as a ferric salt into the wastewater, FeCl₂ as a ferrous salt may be introduced into the wastewater, as described above.

A wastewater treatment system 1 of the present invention is a system for treating the wastewater containing oxidizing substances and arsenic, and as illustrated in FIG. 4, is provided with the reaction vessel 3, measuring device 22, and FeCl₂ feeding device 24. The reaction vessel 3 stores the wastewater. The measuring device 22 measures oxidation-reduction potential (ORP) of the wastewater stored in the reaction vessel 3. The FeCl₂ feeding device 24 introduces FeCl₂ into the reaction vessel 3 based on the output from the measuring device 22.

Such a wastewater treatment system 1 makes it possible to determine, based on the output from the measuring device 22, whether or not the amount of FeCl₂ necessary to reduce the oxidizing substances has been introduced into the wastewater. As a result of this determination, as much FeCl₂ as necessary enough to reduce the oxidizing substances can be introduced into the wastewater. Furthermore, completely reducing the oxidizing substances in the wastewater ensures precipitation of the solid matter in the wastewater. Consequently, the arsenic can be reliably removed from the wastewater. Herein, in the wastewater treatment system 1 described above, the reaction vessel 3 may be equipped solely with the feeding device 24 for introducing FeCl₂ as a ferrous salt.

### EXPERIMENTAL EXAMPLE 1

In order to confirm advantages of the present invention, the experiment in which a precipitation rate of the flocculated solid matter (sludge) in adding as flocculate only FeCl₃ to the wastewater is compared with that in charging FeCl₂ and FeCl₃ into the wastewater was conducted. The experiment will be described below.

### Experimental Method

First, arsenic-containing wastewater including a polishing agent as oxidizing substance was prepared. The wastewater was produced as a result of GaAs wafer polishing process, with INSEC® (from Fujimi Incorporated) being contained as polishing agent. Furthermore, the wastewater pH and ORP were respectively 7.1 and 630 mV. Moreover, concentration of the arsenic contained in the wastewater was 37 ppm.

A liter of the wastewater was poured in beakers as test samples for the comparative example and embodiment. Furthermore, into one of the beakers into which the wastewater as the embodiment test sample was poured, 50 cc solution containing 5% Ca(OH)₂ as pH adjuster, and then 2 cc solution containing 33% FeCl₂ and additionally only 4 cc solution containing 0.1% flocculation aid were introduced.

On the other hand, into the other of the beakers into which the wastewater as comparative example test sample was poured, 50 cc solution containing 5% Ca(OH)₂ as pH adjuster, and then 2 cc solution containing 38% FeCl₃ and only 4 cc solution containing 0.1% flocculation aid were introduced.

Subsequently, the wastewater was stirred for a fixed period of time after the flocculation aid was introduced, and from when the stirring was completed, precipitated level of the solid matter (sludge) flocculated in the wastewater in accordance with the passage of time was visually measured. Specifically, the most upper boundary position of where the sludge was present in the wastewater (the boundary between the solution region in which only solution is present with no sludge and the region in which the sludge is present) was visually checked, and a ratio of the interval from the beaker bottom wall to the boundary position with respect to the distance (wastewater depth) from the beaker bottom wall to the wastewater surface was measured. The measurement was carried out several times whenever a fixed period of time passed from when the stirring was completed.

### Measurement Results

As to the comparative example test sample, above ratio was 90% two minutes after the stirring was completed, and was 70% even when 5 minutes passed. And, the ratio was approximately 55% when 10 minutes passed. On the other hand, as to the embodiment test sample, the ratio becomes about 40% approximately one minute after the stirring was completed, and dropped to 30% two minutes later. Furthermore, as to the embodiment test sample, arsenic concentration of the treated solution from which the precipitates had been removed was 0.034 ppm, which meant that arsenic was removed sufficiently.

Such a measurement result proves that the embodiment of the present invention has a faster precipitate precipitation rate in the wastewater than the comparative example. The possible cause is that FeCl₂ introduced into the wastewater in the embodiment reduces the oxidizing substances to heighten precipitability of the flocculated solid matter, and with the reduction of the oxidizing substances, bivalent iron ions of which FeCl₂ is composed changed into trivalent iron ions, which acted as flocculant.

### EXPERIMENTAL EXAMPLE 2

Next, arsenic-containing wastewater discharged from a plant was treated by the wastewater treatment method of the present invention. Specifically, wastewater in GaAs wafer polishing process was subjected to the following wastewater treatment. Herein, undiluted solution of the wastewater had arsenic concentration of 40 ppm, ORP of 650 mV, and pH of 6.8. Furthermore, the wastewater was subjected to the conventional flocculation-precipitation method in which only FeCl₃ was employed, but flocculated solid matter could not sufficiently precipitated with the wastewater being undiluted. Therefore, the undiluted solution was diluted to two times lower concentration, and then was subjected to the treatment.

First, as in the step (S20) in FIG. 1, Ca(OH)₂ for pH adjustment was introduced into the undiluted solution of the wastewater so that the wastewater pH was made from 11.5 to 11.8. As a result, the wastewater pH was brought to 11.8.

Next, as in the step (S30) in FIG. 1, FeCl₃ and FeCl₂ were introduced into the wastewater. In this introduction, the FeCl₃ was introduced so that the wastewater pH after the treatment fell within the range from 7 to 7.5 inclusive, and on the other hand, as represented in FIG. 2, the amount of the introduced FeCl₂ was adjusted so that the wastewater oxidation-reduction potential (ORP) was brought to 30 mV.

Subsequently, as in the step (S40) in FIG. 1, acrylamide-sodium acrylate copolymer was introduced as flocculate into the wastewater. The amount of charged flocculation aid was defined so as to be 2 ppm with respect to the wastewater.

After the introduction of acrylamide-sodium acrylate copolymer, in the wastewater, the flocculated solid matter were precipitated. The precipitate precipitation rate sufficiently fastened. Subsequently, the precipitates and the residual solution (treated solution) were separated. The treated solution had arsenic concentration of 0.05 ppm. As just described, the wastewater treatment method of the present invention made it possible to subject the wastewater that could not be conventionally treated without dilution to the treatment in which arsenic was removed with the wastewater being undiluted.

The presently disclosed embodiments and implementation examples should in all respects be considered to be illustrative and not limiting. The scope of the present invention is set forth not by the foregoing description but by the scope of the patent claims, and is intended to include meanings equivalent to the scope of the patent claims and all modifications within the scope.

The present invention is applied to treatment of arsenic-containing wastewater, and particularly, is applied advantageously to treatment of arsenic-containing wastewater including oxidizing substances.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A system for treating wastewater containing an oxidizing substance and arsenic, comprising:
a reaction vessel for holding wastewater;
a measuring device for measuring the oxidation-reduction potential of wastewater held in the reaction vessel; and
a feeding device for introducing a ferrous salt into the reaction vessel, based on output from the measuring device.
